(19) United States
(12) Patent Application Publication
(10) Pub. No.: US 2020/0299845 A1
(43) Pub. Date: Sep. 24, 2020

(54) COATED COMBUSTION COMPONENT FROM LIQUID PRECURSOR THERMAL SPRAYING

(71) Applicant: UNIVERSITY OF CONNECTICUT, Farmington, CT (US)

(72) Inventor: Eric Hopkins Jordan, Storrs, CT (US)

(21) Appl. No.: 16/825,847

(22) Filed: Mar. 20, 2020

Related U.S. Application Data
(60) Provisional application No. 62/821,561, filed on Mar. 21, 2019.

(51) Int. Cl. C23D 5/02; C03C 3/19; C03C 3/17; C03C 3/062; C03C 3/087; F01L 3/04; F01N 13/10

(52) U.S. Cl. CPC C23D 5/02; C03C 3/19; C03C 3/17; F01N 13/102; C03C 3/087; F01L 3/04; C03C 3/062

(57) ABSTRACT

A process for the manufacture of a coated combustion component. The process includes spraying one or more liquid or powdered precursors into a high temperature thermal jet directed to a surface of a combustion component and forming a surface coating derived from the precursors to provide the coated combustion component. The surface coating may comprise a phosphate glass or a silicate glass. The surface coating may have a coefficient of thermal expansion from 3 to 26 ppm/K. A coefficient of thermal expansion of the combustion component may be greater than or equal to the coefficient of thermal expansion of the surface coating. The spraying may comprise solution spraying, powder thermal spraying, suspension thermal spraying, or a combination thereof.

### CROSS REFERENCE TO RELATED APPLICATION

This application claims the benefit of U.S. Provisional Application No. 62/821,561, filed Mar. 21, 2019, which is incorporated herein by reference.

### STATEMENT REGARDING FEDERALLY SPONSORED RESEARCH OR DEVELOPMENT

This invention was made with government support under grant number CBET-1258714 awarded by the National Science foundation. The government has certain rights in the invention.

### BACKGROUND

Insulated coatings applied to the combustion components of internal combustion (IC) engines can reduce heat loss, improve engine efficiency, improve emission quality, and maximize specific power output. One method to achieve this purpose is to apply an insulating ceramic coating to the combustion components. A wide range of ceramics, including yttria stabilized zirconia and gadolinium zirconate, have favorable thermal barrier properties and may be applied by a variety of coating processes. The primary difficulty has been the buildup of dense carbon deposits in the pores and surfaces of the coating, which increases thermal conductivity and degrades the insulation properties of the coatings. Ceramic coatings are also expensive.

To improve the performance of IC engines, two properties should be minimized: volumetric heat capacity and thermal conductivity. Since the specific heat for most oxides on a mass basis is fairly similar, reduced density is desirable. In considering theoretical thermal conductivity, it is known that there is lower conductivity limit, what is called the “amorphous limit.” Glass is amorphous and has lower density compared to many ceramics, but glass is a brittle material and typically cannot survive the pressure and thermal shock environment of an IC engine environment.

There remains a need in the art for thermal barrier coatings for combustion components that are comparatively inexpensive, provide adequate insulation to improve engine efficiency, and are suitable for coating combustion components having a range of coefficients of thermal expansion (CTE). Moreover, there is a need for thermal barrier coatings that are suitable for aluminum engine components.

### BRIEF DESCRIPTION

Disclosed herein is a process for the manufacture of a coated combustion component that includes spraying one or more liquid or powder precursors into a high temperature gas jet directed to a surface of a combustion component, and forming a surface coating derived from the precursors to provide the coated combustion component, wherein the surface coating comprises a phosphate glass or a silicate glass, wherein the surface coating has a coefficient of thermal expansion from 3 to 26 ppm/K, and wherein a coefficient of thermal expansion of the combustion component is greater than or equal to the coefficient of thermal expansion of the surface coating. While one would assume glass it too brittle to work in an internal combustion (IC) engine environment due to the shock loading of combustion, the inventor has tested this in a motorcycle IC engine and found such coating do work.

Also provided is a coated combustion component manufactured by the process disclosed herein.

An internal combustion engine comprises the coated combustion component. Non-limiting examples of internal combustion engines include engines that burn liquid fuels, such as gasoline, diesel, ethanol, etc. and gaseous fuels such as natural gas, propane, etc.

Various embodiments are listed below. It will be understood that the embodiments listed below may be combined not only as listed below, but in other suitable combinations in accordance with the scope of the invention.

In an embodiment of the disclosed process for the manufacture of a coated combustion component, the process includes the steps of spraying one or more precursors into a high temperature thermal jet directed to a surface of a combustion component; forming a surface coating derived from the precursors to provide the coated combustion component, wherein the surface coating comprises a phosphate glass or a silicate glass, wherein the surface coating has a coefficient of thermal expansion from 3 to 26 ppm/K, and wherein a coefficient of thermal expansion of the combustion component is greater than or equal to the coefficient of thermal expansion of the surface coating. The spraying may include solution spraying, powder thermal spraying, suspension thermal spraying, or a combination thereof.

In one or more embodiments, the precursor may comprise an aqueous solvent precursor, an organic solvent precursor, a powder precursor, or a combination thereof.

In one or more embodiments, the aqueous solvent precursor comprises ammonium hydroxide, nitric acid, phosphoric acid, boric acid, sodium salt, potassium salt, lead salt, aluminum salt, iron salt, barium salt, calcium salt, magnesium salt, lithium salt, lanthanide salt, strontium salt, yttrium salt, colloidal silica, hydrates thereof, or a combination thereof, and wherein the anion of the salt comprises nitrate, sulfate, bicarbonate, chloride, phosphate, or a combination thereof.

In one or more embodiments, the organic solvent precursor may be selected from boron salt, sodium salt, potassium salt, lead salt, aluminum salt, iron salt, barium salt, calcium salt, magnesium salt, silicon salt, strontium salt, yttrium salt, lanthanide salt, boric acid, hydrates thereof, or a combination thereof, and wherein the anion of the salt comprises C₂₋₆ carboxylate, C₁₋₆ alkoxide, acetylacetonate, nitrate, chloride, tetraethyl orthosilicate (TEOS)or a combination thereof.

In any embodiment herein, the thermal spraying may be a high velocity oxygen fuel spraying, high velocity air fuel spraying, plasma spraying, electric arc spraying, flame spraying, or detonation gun spraying.

In one or more embodiments, a spray distance may be less than 10 cm.

In any embodiment herein, the surface coating may be a phosphate glass. The aqueous solvent precursor may comprise phosphoric acid and at least one of boric acid, sodium salt, potassium salt, lead salt, aluminum salt, iron salt, barium salt, calcium salt, magnesium salt, lithium salt, lanthanide salt, strontium salt, yttrium salt, zirconium salt, colloidal silica, hydrates thereof, or a combination thereof, and wherein the anion of the salt comprises nitrate, sulfate, bicarbonate, chloride, phosphate, or a combination thereof; and the organic solvent precursor may comprise boron salt, sodium salt, potassium salt, lead salt, aluminum salt, iron salt barium salt, calcium salt, magnesium salt, silicon salt, strontium salt, yttrium salt, zirconium salt, lanthanide salt, boric acid, hydrates thereof, or a combination thereof, and wherein the anion of the salt comprises C₂₋₆ carboxylate, C₁₋₆ alkoxide, acetylacetonate, nitrate, or a combination thereof.

In one or more embodiments, the surface coating may comprise one or more of: 10 to 25 wt %, preferably 12 to 23 wt %, even more preferably 14 to 21 wt % of Na₂O; 10 to 25 wt %, preferably 12 to 23 wt %, more preferably 15 to 20 wt % of K₂O; 2 to 20 wt %, preferably 4 to 18 wt %, more preferably 6 to 16 wt % of Al₂O₃; 25 to 60 wt %, preferably 30 to 50 wt %, more preferably 35 to 50 wt % of P₂O₅ or P₂O₃; 5 to 15 wt %, preferably 6 to 14 wt %, more preferably 7 to 13 wt % of PbO, BaO, or a combination thereof; 0 to 25 wt %, preferably 1 to 10%, more preferably 1 to 3 wt % of TiO₂; 0 to 25 wt %, preferably 1 to 10%, more preferably 1 to 3 wt % of CaO; 0 to 25 wt %, preferably 1 to 10%, more preferably 1 to 3 wt % of Fe₂O₃, wherein the amounts are based on the total weight of the surface coating.

In any embodiment herein, the combustion component may comprise aluminum or aluminum alloy.

In any embodiment herein, the surface coating may have a coefficient of thermal expansion from 9 to 26 ppm/K, preferably 12 to 26 ppm/K, more preferably 14 to 24 ppm/K, even more preferably 15 to 20 ppm/K.

In any embodiment herein, the surface coating may be a silicate glass and the aqueous solvent precursor may comprise ammonium hydroxide, nitric acid, boric acid, sodium salt, potassium salt, lead salt, aluminum salt, iron salt, barium salt, calcium salt, magnesium salt, lithium salt, lanthanide salt, strontium salt, yttrium salt, zirconium salt, colloidal silica, hydrates thereof, or a combination thereof, wherein the anion of the salt comprises nitrate, sulfate, bicarbonate, chloride, phosphate, or a combination thereof; and the organic solvent precursor comprises boron salt, sodium salt, potassium salt, lead salt, aluminum salt, iron salt barium salt, calcium salt, magnesium salt, silicon salt, strontium salt, yttrium salt, zirconium salt, lanthanide salt, boric acid, hydrates thereof, tetraethyl orthosilicate (TEOS) or a combination thereof, wherein the anion of the salt comprises C₂₋₆ carboxylate, C₁₋₆ alkoxide, acetylacetonate, nitrate, chloride, or a combination thereof.

In one or more embodiments, the surface coating may comprise one or more of: 15 to 85 wt %, preferably 20 to 50 wt %, more preferably 25 to 45 wt % of SiO₂; 10 to 50 wt %, preferably 15 to 45 wt %, more preferably 20 to 40 wt % of CaO; 8 to 35 wt %, preferably 12 to 32 wt %, more preferably 15 to 28 wt % of Al₂O₃; and 1 to 20 wt %, preferably 1 to 15 wt %, more preferably 1 to 10 wt % of MgO, wherein the amounts are based on the total weight of the surface coating.

In any embodiment herein, the combustion component comprises iron, steel, an alloy thereof, or a combination thereof.

In any embodiment herein, the surface coating may have a coefficient of thermal expansion from 3 to 12 ppm/K, preferably 6 to 12 ppm/K, more preferably 8 to 12 ppm/K.

In one or more embodiments, the surface coating may be a calcium, magnesium aluminum silicate (CMAS) glass, and the aqueous solvent precursor may comprise ammonium hydroxide, nitric acid, sodium salt, potassium salt, aluminum salt, iron salt, calcium salt, magnesium salt, titanium salts, colloidal silica, hydrates thereof, ethylenediaminetetraacetic acid (EDTA), or a combination thereof, wherein the anion of the salt may comprise nitrate, sulfate, bicarbonate, chloride, phosphate, or a combination thereof, and the organic solvent precursor comprises sodium salt, potassium salt, aluminum salt, iron salt, calcium salt, magnesium salt, silicon salt, titanium salt, hydrates thereof, or a combination thereof, wherein the anion of the salt comprises C₂₋₆ carboxylate, C₁₋₆ alkoxide, acetylacetonate, nitrate, chloride, tetraethyl orthosilicate (TEOS) or a combination thereof.

In one or more embodiments, the surface coating may comprise one or more of: 15 to 80 wt %, preferably 20 to 60 wt %, more preferably 25 to 55 wt % of SiO₂; 0 to 50 wt %, preferably 0 to 45 wt %, more preferably 0 to 40 wt % of CaO; 0 to 35 wt %, preferably 0 to 22 wt %, more preferably 5 to 20 wt % of Al₂O₃; 1 to 20 wt %, preferably 1 to 15 wt %, more preferably 1 to 10 wt % of MgO; 0 to 15 wt %, preferably 0 to 10 wt %, more preferably 0 to 5 wt % of Na₂O; 0 to 15 wt %, preferably 0 to 10 wt %, more preferably 0 to 5 wt % of K₂O; 0 to 15 wt %, preferably 0 to 10 wt %, more preferably 0 to 5 wt % of Fe₂O₃; 0 to 25 wt % preferably 15 wt % to 25 wt %, more preferably 8 to 12 wt % B₂O₃; 0 to 50 wt %, preferably 15 to 50 wt %, more preferably 32 to 45 wt % of CaSO₄; and 0 to 15 wt %, preferably 0 to 10 wt %, more preferably 0 to 5 wt % of TiO₂; and 0 to 50 wt %, preferably 15 to 50 wt %, more preferably 32 to 45 wt % of CaO, or a combination thereof, wherein the amounts are based on the total weight of the surface coating.

In one or more embodiments, the surface coatings may comprise borosilicate glasses.

In one or more embodiments, the combustion component may comprise iron, steel, an alloy thereof, or a combination thereof.

In one or more embodiments, the surface coating has a coefficient of thermal expansion from 3 to 12 ppm/K, preferably 6 to 12 ppm/K, more preferably 8 to 12 ppm/K.

In any embodiment herein, the combustion component may be a piston, a fire deck, a combustion chamber, a valve, a pin, or a combination comprising at least one of the foregoing, preferably a bowl surface of the piston, a crown surface of the piston, top surfaces of the intake and exhaust valves, a top surface of a cylinder head exposed to a combustion chamber, a wall surface of the cylinder, an exhaust manifold, an exhaust piping, or a combination comprising at least one of the foregoing.

In any embodiment herein, the surface coating may comprise one or more of: a porosity of 0.1 to 30 vol %, preferably 0.1 to 15 vol %, more preferably 0.1 to 5 vol %, based on the total volume of the surface coating; a thickness of 0.002 to 1 mm, preferably 0.05 to 1 mm, more preferably 0.1 to 0.5 mm; a thermal conductivity of 0.25 to 2.5 W/m·K, preferably 0.35 to 2 W/m·K, more preferably 0.4 to 1.8 W/m·K; and a density of 1 to 5 g/mL, preferably 2 to 4.5 g/mL, more preferably 2.4 to 4 g/mL.

In any embodiment herein, the coefficient of thermal expansion of the surface coating may be 1 to 50% less, preferably 1 to 25% less, more preferably 1 to 10% less than the coefficient of thermal expansion of the combustion component

In any embodiment herein, the coefficient of thermal expansion of the surface coating may be substantially the same as the coefficient of thermal expansion of the combustion component.

A coated combustion component may be manufactured by any embodiment herein.

An internal combustion engine may comprise the coated combustion component of any embodiment herein, wherein the engine is a gasoline engine or a diesel engine.

The internal combustion engine may have a combustion efficiency of 0.5 to 25%, preferably 1 to 20%, more preferably 5 to 15% greater than a combustion efficiency of an internal combustion engine without the coated combustion component.

The above described and other features are exemplified by the following figures and detailed description.

### BRIEF DESCRIPTION OF THE DRAWINGS

FIG. 1 is a schematic showing the solution precursor plasma spray process according to an embodiment.

### DETAILED DESCRIPTION

The combustion events in internal combustion (IC) engines take place in a short time period and result in high heat fluxes imposed on the coatings of the combustion components. As the overall engine heats up, the coatings can be further stressed due to mismatches in the coefficient of thermal expansion (CTE) between the metal engine component and the coating produces stresses. Additionally, the high heat flux heats the coatings faster and hotter than the underlying metal component. These stresses lead to different ideal CTE parameters for coating materials. For heating of the metal component and the coating together, the coating preferably has a CTE that matches the component CTE. For a high transient heat flux, the coating preferably has a CTE lower than the component CTE. As a result, the suitable CTE values vary widely from about 24 ppm/K to as low as 3 ppm/K.

Moreover, coatings in diesel and gasoline engines have different specifications. The expected maximum surface temperatures and pressures are greater in diesel engines, which commonly use steel and cast iron for components, as compared to gasoline engines that commonly use aluminum and aluminum alloy components. Since steel/cast iron components have a lower CTE (e.g., about 9-11 ppm/K) than aluminum components (e.g., about 19-24 ppm/K), the coatings in diesel engines have preferable CTEs that are less than the CTEs that are preferable for coatings in aluminum-based gasoline engines. Accordingly, a wide range of different surface coatings can be used to accommodate diesel and gasoline engines.

Applicant has discovered that glass coatings can be specifically formulated to have a suitable CTE and tolerance for the water vapor contained in the combustion environment. The CTE can be adjusted based on the combustion component material. Moreover, glass coatings are capable of forming a complex mechanical seal characterized in having a low gas permeability, a high chemical durability, and a high mechanical strength. Glass materials further can have lower thermal conductivities and lower densities, leading to lower thermal inertia and improved engine performance, and ultimately to lower costs.

The process for the manufacture of a coated combustion component includes spraying one or more liquid precursors into a high temperature thermal jet that is directed to a surface of a combustion component and forming a surface coating derived from the liquid precursors to provide the coated combustion component. The surface coating can be derived directly from the liquid precursors, and it can also be derived from full or partially reacted liquid precursors, melted solid materials derived from the liquid precursors or by other means, or combinations thereof. The surface coating includes a phosphate glass or a silicate glass having a coefficient of thermal expansion from 3 to 26 parts per million per degree Kelvin (ppm/K). The coefficient of thermal expansion (CTE) of the combustion component is greater than or equal to the coefficient of thermal expansion of the surface coating.

The liquid precursor can include an aqueous solvent precursor, an organic solvent precursor, or a combination thereof. One or more different liquid precursors can be used, including one or more aqueous solvent precursors and one or more organic solvent precursors. For example 2, or 3, or 4, or 5, or 6, or 7, or 8, or 9, or 10, or 11, or 12 liquid precursors can be used, wherein each liquid precursor is independently an aqueous solvent precursor or an organic solvent precursor.

The aqueous solvent precursor can include one or more of ammonium hydroxide, nitric acid, phosphoric acid, boric acid, sodium salt, potassium salt, lead salt, aluminum salt, iron salt, barium salt, calcium salt, magnesium salt, lithium salt, lanthanide salt, strontium salt, yttrium salt, zirconium salt, colloidal silica, hydrates thereof, or a combination thereof, wherein the anion of the salt comprises nitrate, sulfate, bicarbonate, chloride, phosphate, or a combination thereof.

The silicon source may include colloidal silica.

Sodium salts of the aqueous solvent precursor include sodium nitrate, sodium chloride, sodium bicarbonate, sodium sulfate, sodium bisulfate, sodium phosphate, sodium hydrogen phosphate, a hydrate hereof, or a combination thereof.

Potassium salts of the aqueous solvent precursor include potassium nitrate, potassium chloride, potassium bicarbonate, potassium sulfate, potassium phosphate, potassium hydrogen phosphate, a hydrate thereof, or a combination thereof.

Lead salts of the aqueous solvent precursor include lead nitrate, lead sulfate, lead phosphate, lead bicarbonate, a hydrate thereof, or a combination thereof.

Aluminum salts of the aqueous solvent precursor include aluminum nitrate, aluminum chloride, aluminum sulfate, aluminum sulfate hydrogen, a hydrate thereof, or a combination thereof.

Iron salts of the aqueous solvent precursor include iron nitrate, iron chloride, iron phosphate, iron sulfate, a hydrate thereof, or a combination thereof.

Barium salts of the aqueous solvent precursor include barium nitrate, barium chloride, or a hydrate thereof.

Calcium salts of the aqueous solvent precursor include calcium nitrate, calcium chloride, calcium bicarbonate, calcium sulfate, calcium bisulfate, calcium phosphate tribasic, tricalcium phosphate, calcium phosphate dibasic, calcium phosphate monobasic, a hydrate thereof, or a combination thereof.

Magnesium salts of the aqueous solvent precursor include magnesium nitrate, magnesium chloride, magnesium bicarbonate, magnesium sulfate, magnesium hydrogen sulfate, a hydrate thereof, or a combination thereof.

Lithium salts of the aqueous solvent precursor include lithium nitrate, lithium orthophosphate, lithium sulfate, lithium chloride, a hydrate thereof, or a combination thereof.

Lanthanide salts of the aqueous solvent precursor include cerium nitrate, cerium phosphate, cerium sulfate, cerium chloride, dysprosium nitrate, dysprosium chloride, erbium nitrate, erbium chloride, gadolinium nitrate, gadolinium sulfate, gadolinium chloride, holmium nitrate, holmium chloride, lanthanum nitrate, lanthanum phosphate, lanthanum sulfate, lanthanum chloride, lutetium nitrate, lutetium sulfate, lutetium chloride, neodymium nitrate, neodymium chloride, samarium nitrate, samarium sulfate, samarium chloride, terbium nitrate, terbium chloride, thulium nitrate, thulium chloride, ytterbium nitrate, ytterbium sulfate, ytterbium chloride, a hydrate thereof, or a combination thereof.

Strontium salts of the aqueous solvent precursor include strontium nitrate, strontium chloride, or a hydrate thereof.

Yttrium salts of the aqueous solvent precursor include yttrium nitrate, yttrium phosphate, yttrium sulfate, yttrium chloride, a hydrate thereof, or a combination thereof.

Zirconium salts of the aqueous solvent precursor include zirconium nitrate, zirconium phosphate, zirconium sulfate, zirconium chloride, a hydrate thereof, or a combination thereof.

The organic solvent precursor can include one or more of boron salt, sodium salt, potassium salt, lead salt, aluminum salt, iron salt, barium salt, calcium salt, magnesium salt, silicon salt, strontium salt, yttrium salt, lanthanide salt, boric acid, hydrates thereof, or a combination thereof, wherein the anion of the salt comprises C₂₋₆ carboxylate (e.g., acetate, propionate), C₁₋₆ alkoxide, acetylacetonate, nitrate, chloride, a hydrate thereof, or a combination thereof.

Boron salts of the organic solvent precursor include boron acetate, triethyl borate, trimethyl borate, tri-isopropyl borate, tributyl borate, boron trichloride, a hydrate thereof, or a combination thereof.

Sodium salts of the organic solvent precursor sodium acetate, sodium propionate, sodium methoxide, sodium ethoxide, sodium isopropoxide, sodium t-butoxide, sodium t-pentoxide, sodium acetylacetonate, a hydrate thereof, or a combination thereof.

Potassium salts of the organic solvent precursor include potassium acetylacetonate, potassium acetate, potassium propionate, potassium ethoxide, potassium methoxide, potassium t-pentoxide, potassium isopropoxide, potassium t-butoxide, potassium acetylacetonate, a hydrate thereof, or a combination thereof.

Lead salts of the organic solvent precursor lead acetate, lead propionate, lead acetylacetonate, a hydrate thereof, or a combination thereof.

Aluminum salts of the organic solvent precursor include aluminum s-butoxide, aluminum ethoxide, aluminum propoxide, aluminum isopropoxide, dimethylaluminum isopropoxide, magnesium aluminum isopropoxide, aluminum acetylacetonate, a hydrate thereof, or a combination thereof.

Iron salts of the organic solvent precursor include iron acetate, iron acetylacetonate, iron isopropoxide, a hydrate thereof, or a combination thereof.

Barium salts of the organic solvent precursor include barium acetate, barium isopropoxide, barium acetylacetonate, a hydrate thereof, or a combination thereof.

Calcium salts of the organic solvent precursor include calcium acetate, calcium methoxide, calcium isopropoxide, calcium acetylacetonate, a hydrate thereof, or a combination thereof.

Magnesium salts of the organic solvent precursor include magnesium acetate, magnesium ethoxide, magnesium isopropoxide, magnesium aluminum isopropoxide, magnesium acetylacetonate, a hydrate thereof, or a combination thereof.

Silicon salts of the organic solvent precursor include tetra(C₁₋₃ alkyl)orthosilicates such as tetramethoxysilane, tetraethoxysilane (TEOS), and tetrabutoxysilane; tri(C₁₋₆ alkyl)silanols such as tri-t-butoxysilanol and tri-t-pentoxysilanol, silicon tetrachloride, a hydrate thereof, or a combination thereof.

Strontium salts of the organic solvent precursor include strontium acetate, strontium isopropoxide, strontium acetylacetonate, a hydrate thereof, or a combination thereof.

Yttrium salts of the organic solvent precursor include yttrium acetate, yttrium isopropoxide, yttrium acetylacetonate, a hydrate thereof, or a combination thereof.

Lanthanide salts of the organic solvent precursor include lanthanum acetate, lanthanum isopropoxide, lanthanum acetylacetonate, cerium acetate, cerium acetylacetonate, dysprosium acetate, dysprosium isopropoxide, dysprosium acetylacetonate, erbium acetate, erbium isopropoxide, erbium acetylacetonate, gadolinium acetate, gadolinium isopropoxide, gadolinium acetylacetonate, holmium acetate, neodymium acetate, neodymium isopropoxide, samarium acetate, samarium isopropoxide, samarium acetylacetonate, terbium acetylacetonate, thulium acetate, thulium acetylacetonate, ytterbium acetate, ytterbium isopropoxide, ytterbium acetylacetonate, a hydrate thereof, or a combination thereof.

Liquid precursors such as nitric acid, phosphoric acid, boric acid, and ammonium hydroxide can be used to provide atomic precursors and/or to adjust the pH of the liquid precursor solution. In some embodiments, phosphoric acid can be used as source for phosphorous atoms.

The liquid precursors can be prepared by contacting the appropriate aqueous solvent precursor(s) or organic solvent precursor(s) with an aqueous solvent or an organic solvent, respectively. The aqueous solvent precursor further includes water, for example deionized water, as a solvent. The organic solvent precursor further includes an organic solvent. Suitable organic solvents include, but are not limited to, C₁₋₅ alcohols such as methanol, ethanol, ethylene glycol, or the like; ethyl acetate, acetone, methyl ethyl ketone, methyl isobutyl ketone, or a combination thereof.

In some embodiments, the liquid precursors prepared from the aqueous solvent precursor and/or the organic solvent precursor can further include a viscosity modifier. Any suitable viscosity modifier can be used. Examples of suitable viscosity modifiers include nonionic polymers including polyethers such as polyethylene glycol, polyvinyl alcohol, polyvinylpyrrolidone, polyvinyl acetate, polyvinyl benzyltrimethylammonium chloride, aqueous urethane resins, gum arabic, chitosan, cellulose, crystalline cellulose, methylcellulose, ethylcellulose, hydroxyethylcellulose, carboxymethylcellulose, carboxymethylcellulose ammonium, carboxymethylcellulose, carboxyvinyl polymers, lignin sulfonate, starch, or a combination thereof. The content of the viscosity modifier can be within a range from 0.01 to 10 wt % based on the total weight of the liquid precursor. In an embodiment, the viscosity modifier is a poly(vinyl C₁₋₅ alcohol).

In some embodiments, the liquid precursors can further include other additives. Additives include, but are not limited to, a dispersant, agglomerating agent, antifoaming agent, or a combination thereof.

The precursor reagents (i.e., the aqueous and organic solvent precursors) are weighed according to the desired stoichiometry of the surface coating, i.e., according to the desired stoichiometry of the mixed oxide, and then added and mixed to form the solution. As required, precursor stoichiometry may be adjusted to compensate for selective element loss during spraying to achieve the desired coating stoichiometry. The precursor solution may be heated and stirred to dissolve the solid components and homogenize the solution. Each liquid precursor can include one or more aqueous solvent precursor or one or more organic solvent precursor. The pH value of the resulting liquid precursor can be adjusted by addition of the appropriate acid or base. The liquid precursors can be prepared in a single step or in multiple steps. In some embodiments, an aqueous solvent precursor or organic solvent precursor is contacted with an aqueous solvent or an organic solvent to form an initial liquid precursor, respectively, optionally the pH is adjusted, and then one or more additional aqueous solvent precursor or one or more additional organic solvent precursor is then contacted with the initial liquid precursor, and the pH is optionally adjusted again. In an embodiment, one or more precursors are added or combined in separate steps to provide the liquid precursor.

The surface coatings can be applied to substrates such as combustion components using any suitable spraying method, for example thermal spraying. Preferably the spraying comprises solution spraying, powder thermal spraying, suspension thermal spraying, or a combination thereof. In the spray process of applying the coatings from liquid precursor solutions, five steps are preferably involved: (1) preparation of the precursor solution; (2) delivery of the precursor solution; and (3) conversion of the precursor solution into a solid material in a pyrolysis reaction; (4) melting of the solid material; (5) deposition of the melted materials (and optionally mixing in addition solid components) on a target substrate to form a coating, film, or bulk form. Delivery of the solution typically comprises spraying of the solution into a high temperature thermal jet, which might be a flame or plasma stream, which is directed at a surface of the substrate. The substrate is temperature controlled and may be heated, cooled or neither heated nor cooled. Conversion of the solution typically comprises the pyrolytic reaction of the sprayed precursor solution producing a coating having the desired microstructure. Similarly, the spray processes of applying powder or suspension precursors involve a precursor powder or a precursor suspension, respectively. Suitable methods of thermal spraying can include, for example high velocity oxygen fuel spraying, high velocity air fuel spraying, plasma spraying, electric arc spraying, flame spraying, and detonation gun spraying.

In some embodiments, the surface of the substrate or combustion component can be pre-treated before the deposition of the surface coating. Suitable methods for pre-treatment include, but are not limited to, cleaning, grit blasting, and application of a bond coat layer by any suitable method (e.g., thermal spraying), roughening, polishing, or the like.

In some embodiments of thermal spray methods, coating materials in powder form can be injected into the hot output of the thermal spray torch as gas fluidized powder from the side (e.g., radial injection) of the hot output to the torch flame or plasma jet, or coaxially with the hot output (e.g., axial injection). In an additional embodiment, material can be deposited by thermal torches by suspending precursors in a liquid and depositing the proposed coatings by injecting this suspension into the thermal torch in the process referred to as suspension thermal spray.

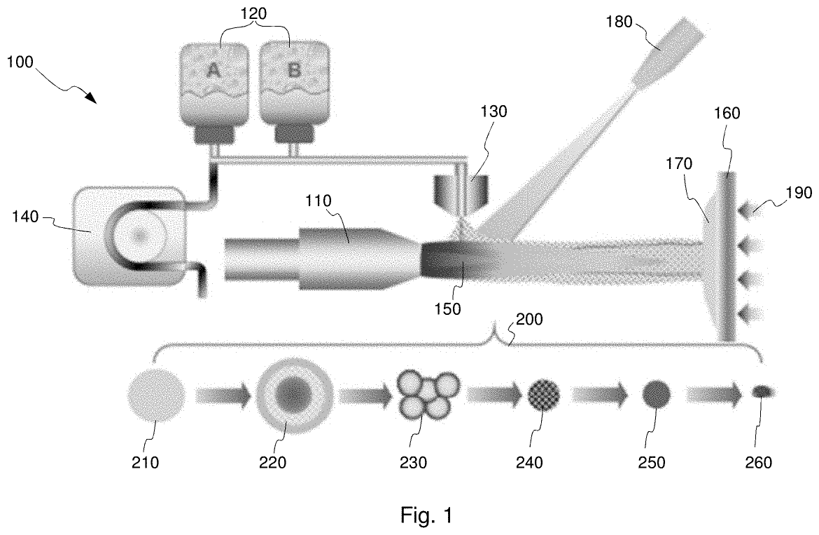

In an embodiment, a solution spray process is used that creates coatings using thermal spray torches including plasma torches, combustion torches, high velocity oxygen fuel torches, detonation guns, or the like. In the solution spray process liquid precursors, as solutions or colloids, are injected in place of the powder. The liquid precursor may be in an aqueous solvent or an organic solvent. The liquid precursors may be injected as a solid stream or in an atomized form. FIG. 1 shows the details of a solution precursor plasma spray method, which is an exemplary method of thermal solution spraying. In a particular embodiment, the method of spraying is solution precursor plasma spraying (SPPS).

In an embodiment illustrated in FIG. 1, the method of spraying is plasma spraying, which can be combined with or used in various spraying methods, e.g., SPPS. The plasma spray apparatus 100 preferably comprises a plasma gun arranged to receive liquid precursors from a liquid precursor delivery system. The liquid precursor delivery system includes one or more liquid precursors 120 and a liquid injector 130. A pump 140, such as a peristaltic pump, a pressure and volume controlled pump, or regulated pressurized tank, controls delivery of the liquid precursors 120 to the liquid injector 130. If powder precursors are used instead of liquid precursors, the a commercial powder feeder may control delivery of the powders to suitable injectors. The liquid injector preferably provides an atomized spray of the liquid precursor from a single or multiple atomizing liquid injector(s), disposed in fluid communication with the liquid precursor delivery system. The plasma gun 110 provides a high temperature as a jet from the arc heating of primary and/or secondary gases, which is directed from an anode nozzle to substrate. In one non-limiting embodiment, the primary gas may be either argon or nitrogen, and the secondary gas may be either hydrogen or helium. Although the plasma can be generated from the primary gas alone, the secondary gas can be used for voltage control and can provide higher thermal conductivity of the gas for better heat transfer. It can additionally provide power to the plasma and increase the plasma enthalpy for higher flame temperature. The liquid precursor injector 130 is not limited to an atomizing injector and can be a direct liquid injection nozzle that produces a solid liquid stream or a piezo electric crystal induced liquid injector.

In an embodiment shown in FIG. 1, when plasma spraying is selected as the spraying method, the liquid precursors can be directly injected into the high temperature area in the center of the plasma flame 150 in a radial direction, in the form of linear solid stream jet flow through a catheter having a diameter of 201 to 400 microns, preferably 250 to 400 microns, more preferably 275 to 400 microns. The distance between the plasma gun 110 and the combustion component 160 (i.e., the spray distance) can be less than 10 cm, preferably 1 to 9 centimeters, more preferably 2 to 8 centimeters. In some embodiments, the plasma spray power is greater than 60 kW, preferably 65 to 100 kW. In still other embodiments, the plasma spray power is 30 to 60 kW.

After deposition the coating material 170 may be subjected to a post-treatment such as heat treatment, cleaning, surface finishing, near surface finishing, and combinations of two or more of the foregoing. Appropriate post-treatment process or processes are readily determined by one of ordinary skill in the art depending upon the surface coating, the underlying substrate or combustion component, and the intended use.

The plasma spray apparatus may include one or more sensors 180 to monitor entrainment of the one or more liquid precursors in the plasma flame 150.

During the plasma spray process the temperature of the substrate 160 may be controlled through one or more temperature control devices 190, including heaters, coolers, heat exchanges, etc.

As the one or more liquid precursors 120 are injected into the high temperature area in the center of the plasma flame 150, they undergo physical and chemical change in rapid succession. First, primary or secondary break-up 210, followed by evaporation and precipitation 220, shell fragmentation 230, pyrolysis 240, sintering 250, and finally melting 260.

In still other embodiments, the spraying can include the use of powder precursors or final material in powder form to provide the coated combustion component described herein. In some embodiments, the spraying can include the use of a powder precursor in a slurry. In such a case the powder or suspension can be introduced in the thermal jet form both a radial location as in injector 130 shown in FIG. 1 and/or by axial injection as is possible with some thermal spray devices, for example, Metco Diamond Jet or the Axial III. Any suitable method, such as plasma spraying, can be used to form the surface coating.

In some embodiments, the surface coating can be a phosphate glass. Suitable aqueous solvent precursors include phosphoric acid and at least one of boric acid, sodium salt, potassium salt, lead salt, aluminum salt, iron salt, barium salt, calcium salt, magnesium salt, lithium salt, lanthanide salt, strontium salt, yttrium salt, zirconium salt, colloidal silica, hydrates thereof, or a combination thereof, and wherein the anion of the salt comprises nitrate, sulfate, bicarbonate, chloride, phosphate, or a combination thereof. Suitable organic solvent precursors include boron salt, sodium salt, potassium salt, lead salt, aluminum salt, iron salt barium salt, calcium salt, magnesium salt, silicon salt, strontium salt, yttrium salt, zirconium salt, lanthanide salt, boric acid, hydrates thereof, or a combination thereof, wherein the anion of the salt comprises C₂₋₆ carboxylate, C₁₋₆ alkoxide, acetylacetonate, nitrate, or a combination thereof. Additionally, other solid materials can be incorporated into the surface coating using non- thermal spray techniques (e.g., CaF₂ particles can be suspended in the surface coating). In the case of powder spray the phosphor glass may be in the form of phosphor glass powder covering the composition ranges specified above.

The surface coating that is a phosphate glass can include one or more of: 5 to 25 weight percent (wt %), preferably 12 to 23 wt %, even more preferably 14 to 21 wt % of Na₂O; 5 to 25 wt %, preferably 12 to 23 wt %, more preferably 15 to 20 wt % of K₂O; 2 to 20 wt %, preferably 4 to 18 wt %, more preferably 6 to 16 wt % of Al₂O₃; 20 to 60 wt %, preferably 30 to 50 wt %, more preferably 35 to 50 wt % of P₂O₅; 5 to 15 wt %, preferably 6 to 14 wt %, more preferably 7 to 13 wt % of PbO, BaO, or a combination thereof; 0 to 10 wt %, preferably 0 to 8 wt %, more preferably 0 to 6 wt % of Fe₂O₃; and 0 to 20 wt %, preferably 0 to 15 wt %, more preferably 0 to 12 wt % of B₂O₃. In an embodiment, the surface coating that is a phosphate glass includes 5 to 25 weight percent wt %, preferably 12 to 23 wt %, even more preferably 14 to 21 wt % of Na₂O; 5 to 25 wt %, preferably 12 to 23 wt %, more preferably 15 to 20 wt % of K₂O; 2 to 20 wt %, preferably 4 to 18 wt %, more preferably 6 to 16 wt % of Al₂O₃; 20 to 60 wt %, preferably 30 to 50 wt %, more preferably 35 to 50 wt % of P₂O₅ or P₂O₃; 5 to 15 wt %, preferably 6 to 14 wt %, more preferably 7 to 13 wt % of PbO, BaO, or a combination thereof; 0 to 10 wt %, preferably 0 to 8 wt %, more preferably 0 to 6 wt % of Fe₂O₃; and 0 to 20 wt %, preferably 0 to 15 wt %, more preferably 0 to 12 wt % of B₂O₃.

In some embodiments, the surface coating can further include 0 to 20 wt %, preferably 0 to 15 wt %, more preferably 0 to 10 wt % of CaO; 0 to 10 wt %, preferably 0 to 8 wt %, more preferably 0 to 6 wt % of Li₂O; 0 to 10 wt %, preferably 0 to 6 wt %, more preferably 0 to 5 wt % of MgO; 0 to 10 wt %, preferably 0 to 7 wt %, more preferably 0 to 5 wt % of SiO₂; and 0 to 15 wt %, preferably 0 to 10 wt %, more preferably 0 to 5 wt % CaF₂ as suspended particles.

In some embodiments, the surface coating is a phosphate glass that is substantially free of yttria-stabilized zirconia (YSZ). In an embodiment, the surface coating is a phosphate glass that is substantially free of tungsten, niobium, and/or antimony.

In some embodiments, the combustion component that includes the phosphate glass surface coating comprises aluminum or aluminum alloy. As used herein, “aluminum alloy” means an alloy comprising aluminum and at least one other element. Suitable aluminum alloys can include, but are not limited to, aluminum-copper alloys, aluminum-silicon alloys, aluminum-copper-iron alloys, aluminum-copper-magnesium alloys, aluminum-copper-nickel alloys, aluminum-silicon-copper alloys, aluminum-silicon-magnesium alloys, aluminum-copper-nickel-magnesium alloys, aluminum-copper-tin-zinc alloys, aluminum-silicon-copper-manganese alloys, aluminum-silicon-copper-nickel alloys, aluminum-silicon-nickel-copper-manganese alloys, aluminum-silicon-nickel-copper-molybdenum alloys, or the like. In specific embodiments, the aluminum alloy can be aluminum alloy 319, aluminum alloy 319-T5, aluminum alloy A356, aluminum alloy A356-T6, aluminum alloy 380, aluminum alloy AlSi11, aluminum alloy AlSi10, aluminum alloy AlSi9, or the like. In still other embodiments, the combustion component can be a steel alloy having a CTE that is greater than or equal to the CTE of the phosphate glass coating.

The phosphate glass surface coating can have a coefficient of thermal expansion (CTE) that is 9 to 26 ppm/K, preferably 12 to 26 ppm/K, more preferably 14 to 24 ppm/K, even more preferably 15 to 20 ppm/K. The CTE is as determined when measured from 20 to 100° C., 20 to 200° C., 20 to 250° C., 20 to 300° C., or 20 to 400° C. In some embodiments, the phosphate glass surface coating has a CTE that is substantially equal to or less than a CTE of the combustion component. In an embodiment, the CTE of the surface coating is 1 to 80% less, preferably 1 to 50% less, more preferably 1 to 25% less, even more preferably 1 to 10% less than the CTE of the combustion component. For example, the coated combustion component can include a phosphate glass surface coating having a CTE of 12 to 26 ppm/K and an aluminum combustion component having a CTE of 23 to 27 ppm/K.

The phosphate glass surface coating can have a porosity of 0.1 to 30 vol %, preferably 0.1 to 15 vol %, and more preferably 0.1 to 5 vol %, based on the total volume of the surface coating. The phosphate glass surface coating can have a thickness of 0.001 to 1 mm, preferably 0.01 to 1 mm, more preferably 0.1 to 0.5 mm. In some embodiments, the surface coating can include multiple coating layers, including composites or graded coatings, wherein the thickness of the entire surface coating that comprises the multiple coating layers is as defined above.

The phosphate glass surface coating can have a thermal conductivity of 0.25 to 2.5 W/m·K, preferably 0.35 to 2 W/m·K, more preferably 0.4 to 1.8 W/m·K.

The phosphate glass surface coating can have a density of 1 to 5 g/mL, preferably 2 to 4.5 g/mL, more preferably 2.4 to 4 g/mL.

In other embodiments, the surface coating can be a silicate glass. The aqueous solvent precursors can include ammonium hydroxide, nitric acid, boric acid, sodium salt, potassium salt, lead salt, aluminum salt, iron salt, barium salt, calcium salt, magnesium salt, lithium salt, lanthanide salt, strontium salt, yttrium salt, zirconium salt, colloidal silica, hydrates thereof, or a combination thereof, wherein the anion of the salt comprises nitrate, sulfate, bicarbonate, chloride, phosphate, or a combination thereof. Other organic solvent precursors can include boron salt, sodium salt, potassium salt, lead salt, aluminum salt, iron salt barium salt, calcium salt, magnesium salt, silicon salt, strontium salt, yttrium salt, zirconium salt, lanthanide salt, boric acid, hydrates thereof, or a combination thereof, wherein the anion of the salt comprises C₂₋₆ carboxylate, C₁₋₆ alkoxide, acetylacetonate, nitrate, chloride, tetraethyl orthophosphate (TEOS) or a combination thereof.

The surface coating that is a silicate glass can include 15 to 80 wt %, preferably 20 to 50 wt %, more preferably 25 to 45 wt % of SiO₂; 10 to 50 wt %, preferably 15 to 45 wt %, more preferably 20 to 40 wt % of CaO; 8 to 35 wt % , preferably 12 to 32 wt %, more preferably 15 to 28 wt % of Al₂O₃; and 1 to 20 wt %, preferably 1 to 15 wt %, more preferably 1 to 10 wt % of MgO. In some embodiments, the surface coating can further include 0 to 40 wt %, preferably 0 to 30 wt %, more preferably 0 to 20 wt % of P₂O₅; 0 to 25 wt %, preferably 0 to 15 wt %, more preferably 0 to 5 wt % of Na₂O; 0 to 10 wt %, preferably 0 to 6 wt %, more preferably 0 to 4 wt % of K₂O; 0 to 10 wt %, preferably 0 to 6 wt %, more preferably 0 to 3 wt % of Fe₂O₃; 0 to 15 wt %, preferably 0 to 10 wt %, more preferably 0 to 5 wt % of B₂O₃; 0 to 10 wt %, preferably 0 to 6 wt %, more preferably 0 to 3 wt % of Li₂O; and 0 to 25 wt % of TiO₂; and 0 to 15 wt %, preferably 0 to 10 wt %, more preferably 0 to 5 wt % of CaF₂ as suspended particles.

In some embodiments, the surface coating is a silicate glass that is substantially free of yttria-stabilized zirconia (YSZ). In an embodiment, the surface coating is a silicate glass that is substantially free of tungsten, niobium, and/or antimony.

In some embodiments, the combustion component that includes the silicate glass surface coating comprises iron, steel, an alloy thereof, or a combination thereof. Iron and iron alloys can include gray cast iron, compacted graphite cast iron, spheroidal graphite iron. Steel and steel alloys can include carbon steel, manganese steel, nickel steel, nickel-chromium steel, molybdenum steel, chromium-molybdenum steel, nickel-chromium molybdenum steel, nickel-molybdenum steel, chromium steel, chromium-vanadium steel, tungsten chromium steel, silicon-manganese steel, boron steel, leaded steel, tool steel, HSLA steel, or the like. In particular embodiments, the steel or steel alloy can include 422 stainless steel, 304 stainless steel, 21-2N stainless steel, 21-4N stainless steel, M2 tool steel, silchrome 1, silchrome XB, 8440 alloy steel, MoCr4 steel, 42CrMo4 steel, CrMo4 steel, 31CrMoV6 steel, 25MoCr4 steel, 1541H carbon steel, 1547 carbon steel, 4140H steel, 5150H steel, 8645 steel, B16 steel, or the like. In particular embodiments, the combustion component is not a steel alloy that has a CTE of greater than 12 ppm/K.

The silicate glass surface coating can have a coefficient of thermal expansion (CTE) that is 3 to 12 ppm/K, preferably 6 to 12 ppm/K, more preferably 8 to 12 ppm/K. The CTE is as determined when measured from 20 to 100° C., 20 to 200° C., 20 to 250° C., 20 to 300° C., or 20 to 400° C. In some embodiments, the silicate glass surface coating has a CTE that is substantially equal to or less than a CTE of the combustion component. In an embodiment, the CTE of the surface coating is 1 to 80% less, preferably 1 to 50% less, more preferably 1 to 25% less, even more preferably 1 to 10% less than the CTE of the combustion component. For example, the coated combustion component can include a silicate glass surface coating having a CTE of 6 to 12 ppm/K and a cast iron combustion component having a CTE of 9 to 11 ppm/K.

The silicate glass surface coating can have a porosity of 0.1 to 30 vol %, preferably 0.1 to 15 vol %, and more preferably 0.1 to 5 vol %, based on the total volume of the surface coating.

The silicate glass surface coating can have a thickness of 0.001 to 1 mm, preferably 0.01 to 1 mm, more preferably 0.1 to 0.5 mm. In some embodiments, the surface coating can include multiple coating layers, including composites or graded coatings, wherein the thickness of the entire surface coating that comprises the multiple coating layers is as defined above.

The silicate glass surface coating can have a thermal conductivity of 0.25 to 2.5 W/m·K, preferably 0.35 to 2 W/m·K, more preferably 0.4 to 1.8 W/m·K.

The silicate glass surface coating can have a density of 1 to 5 g/mL, preferably 2 to 4.5 g/mL, more preferably 2.4 to 4 g/mL.

Further provided herein is a coated combustion component. Combustion components can be any suitable substrate that is amenable to receiving a surface coating using a thermal spraying method, and is not particularly limited to combustion components of an internal combustion engine. In some embodiments, the combustion component is a piston, a cylinder, a valve, a pin, or a combination thereof, preferably a bowl surface of the piston, a crown surface of the piston, top surfaces of the intake and exhaust valves, a top surface of a cylinder head exposed to a combustion chamber, a wall surface of the cylinder, an exhaust manifold, an exhaust piping, or a combination thereof. In an embodiment, the surface coating is applied to the working surface of a cylinder of a combustion engine.

According to another embodiment, an internal combustion engine includes the coated combustion component. In particular embodiments, the engine is a gasoline engine or a diesel engine. In still other embodiments, the engine is a homogenous charge compression ignition (HCCI) engine.

The internal combustion engine that includes the coated combustion component can have improved combustion properties compared to a substantially similar internal combustion engine that does not include the coated combustion component. In an embodiment, a combustion efficiency of the internal combustion engine is 0.5 to 25%, preferably 1 to 20%, more preferably 5 to 15% greater than a combustion efficiency of an internal combustion engine without the coated combustion component. In another embodiment, an increase in the combustion efficiency of the internal combustion engine is 0.5 to 25%, preferably 1 to 20%, more preferably 5 to 15% compared to the combustion efficiency of an internal engine without the coated combustion component.

This disclosure is further illustrated by the following examples, which are non-limiting.

### EXAMPLES

### Phosphate Glasses

Phosphate glass surface coatings can be formed on an aluminum piston by solution precursor plasma spraying (SPPS). The amount of each component (mol %) in the surface coatings and the corresponding CTEs (ppm/K) are provided in Table 1.

TABLE 1

| Ex- | | | | | | | | | |
|---|---|---|---|---|---|---|---|---|---|
| ample | Na₂O | K₂O | BaO | B₂O₃ | Fe₂O₃ | Al₂O₃ | PbO | P₂O₅ | CTE |
| 1 | 18 | 19 | 9 | 0 | 5 | 12 | 0 | 37 | 19 |
| 2 | 18 | 18 | 9 | 0 | 5 | 9 | 0 | 45 | 20.3 |
| 3 | 18 | 19 | 0 | 6 | 5 | 6 | 9 | 37 | 18.7 |
| 4 | 18 | 19 | 9 | 0 | 4 | 10 | 0 | 40 | 18.7 |
| 5 | 18 | 19 | 0 | 6 | 5 | 8 | 9 | 40 | 20 |
| 6 | 17.3 | 18.2 | 0 | 5.8 | 4 | 7.7 | 8.6 | 38.4 | 17.8 |
| 7 | 15 | 18 | 0 | 6 | 0 | 12 | 9 | 40 | 17.9 |

### Silicate Glasses

Silicate glass surface coatings can be formed on cast iron piston by SPPS. The amount of each component (mol %) in the surface coatings and the corresponding CTEs (ppm/K) are provided in Table 2.

TABLE 2

| Example | CaO | MgO | Al₂O₃ | SiO₂ | Fe₂O₃ | TiO₂ | Na₂O | K₂O | CTE |
|---|---|---|---|---|---|---|---|---|---|
| 8 | 35 | 6 | 21 | 38 | 0 | 0 | 0 | 0 | 10 |
| 9 | 25 | 3.5 | 22 | 42 | 2 | 1.75 | 1.75 | 2 | 9 |

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

Unless defined otherwise, technical and scientific terms used herein have the same meaning as is commonly understood by one of skill in the art to which this disclosure belongs.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A process for the manufacture of a coated combustion component, the process comprising:
spraying one or more precursors into a high temperature thermal jet directed to a surface of a combustion component, wherein the spraying is selected from solution spraying, powder thermal spraying, suspension thermal spraying, or a combination thereof; and
forming a surface coating derived from the one or more precursors to provide the coated combustion component,
wherein the surface coating comprises a phosphate glass or a silicate glass,
wherein the surface coating has a coefficient of thermal expansion from 3 to 26 ppm/K, and
wherein a coefficient of thermal expansion of the combustion component is greater than or equal to the coefficient of thermal expansion of the surface coating.

2. The process of claim 1, wherein the precursor comprises an aqueous solvent precursor, an organic solvent precursor, a powder precursor, or a combination thereof.

3. The process of claim 2, wherein the aqueous solvent precursor comprises ammonium hydroxide, nitric acid, phosphoric acid, boric acid, sodium salt, potassium salt, lead salt, aluminum salt, iron salt, barium salt, calcium salt, magnesium salt, lithium salt, lanthanide salt, strontium salt, yttrium salt, colloidal silica, hydrates thereof, or a combination thereof, and wherein the anion of the salt comprises nitrate, sulfate, bicarbonate, chloride, phosphate, or a combination thereof.

4. The process of claim 2, wherein the organic solvent precursor comprises boron salt, sodium salt, potassium salt, lead salt, aluminum salt, iron salt, barium salt, calcium salt, magnesium salt, silicon salt, strontium salt, yttrium salt, lanthanide salt, boric acid, hydrates thereof, or a combination thereof, and wherein the anion of the salt comprises C₂₋₆ carboxylate, C₁₋₆ alkoxide, acetylacetonate, nitrate, chloride, tetraethyl orthosilicate (TEOS), or a combination thereof.

5. The process of claim 1, wherein the thermal spraying is high velocity oxygen fuel spraying, high velocity air fuel spraying, plasma spraying, electric arc spraying, flame spraying, and detonation gun spraying.

6. The process of claim 5, wherein a spray distance is less than 10 cm.

7. The process of claim 2, wherein the surface coating is a phosphate glass;
the aqueous solvent precursor comprises phosphoric acid and at least one of boric acid, sodium salt, potassium salt, lead salt, aluminum salt, iron salt, barium salt, calcium salt, magnesium salt, lithium salt, lanthanide salt, strontium salt, yttrium salt, zirconium salt, colloidal silica, hydrates thereof, or a combination thereof, and wherein the anion of the salt comprises nitrate, sulfate, bicarbonate, chloride, phosphate, or a combination thereof; and
the organic solvent precursor comprises boron salt, sodium salt, potassium salt, lead salt, aluminum salt, iron salt barium salt, calcium salt, magnesium salt, silicon salt, strontium salt, yttrium salt, zirconium salt, lanthanide salt, boric acid, hydrates thereof, tetraethyl orthosilicate (TEOS)or a combination thereof, and wherein the anion of the salt comprises C₂₋₆ carboxylate, C₁₋₆ alkoxide, acetylacetonate, nitrate, or a combination thereof.

8. The process of claim 7, wherein the surface coating comprises one or more of:
10 to 25 wt % of Na₂O;
10 to 25 wt % of K₂O;
2 to 20 wt % of Al₂O₃;
25 to 60 wt % of P₂O5 or P₂O₃;
5 to 15 wt % of PbO, BaO, or a combination thereof;
0 to 25 wt % of TiO₂;
0 to 25 wt % of CaO; and
0 to 25 wt % of Fe₂O₃, wherein the amounts are based on the total weight of the surface coating.

9. The process of claim 7, wherein the combustion component comprises aluminum or aluminum alloy.

10. The process of claim 7, wherein the surface coating has a coefficient of thermal expansion from 9 to 26 ppm/K.

11. The process of claim 2, wherein the surface coating is a silicate glass;
the aqueous solvent precursor comprises ammonium hydroxide, nitric acid, boric acid, sodium salt, potassium salt, lead salt, aluminum salt, iron salt, barium salt, calcium salt, magnesium salt, lithium salt, lanthanide salt, strontium salt, yttrium salt, zirconium salt, colloidal silica, hydrates thereof, or a combination thereof, wherein the anion of the salt comprises nitrate, sulfate, bicarbonate, chloride, phosphate, or a combination thereof; and
the organic solvent precursor comprises boron salt, sodium salt, potassium salt, lead salt, aluminum salt, iron salt barium salt, calcium salt, magnesium salt, silicon salt, strontium salt, yttrium salt, zirconium salt, lanthanide salt, boric acid, hydrates thereof, or a combination thereof, wherein the anion of the salt comprises C₂₋₆ carboxylate, C₁₋₆ alkoxide, acetylacetonate, nitrate, chloride, tetraethyl orthosilicate (TEOS) or a combination thereof.

12. The process of claim 11, wherein the surface coating comprises one or more of:
15 to 85 wt % of SiO₂;
10 to 50 wt % of CaO;
8 to 35 wt % of Al₂O₃; and
1 to 20 wt % of MgO, wherein the amounts are based on the total weight of the surface coating.

13. The process of claim 11, wherein the combustion component comprises iron, steel, an alloy thereof, or a combination thereof.

14. The process of claim 11, wherein the surface coating has a coefficient of thermal expansion from 3 to 12 ppm/K.

15. The process of claim 2, wherein the surface coating is a CMAS glass;
the aqueous solvent precursor comprises ammonium hydroxide, nitric acid, sodium salt, potassium salt, aluminum salt, iron salt, calcium salt, magnesium salt, titanium salts, colloidal silica, hydrates thereof, ethylenediaminetetraacetic acid (EDTA), or a combination thereof, wherein the anion of the salt comprises nitrate, sulfate, bicarbonate, chloride, phosphate, or a combination thereof; and
the organic solvent precursor comprises sodium salt, potassium salt, aluminum salt, iron salt, calcium salt, magnesium salt, silicon salt, titanium salt, hydrates thereof, or a combination thereof, wherein the anion of the salt comprises C₂₋₆ carboxylate, C₁₋₆ alkoxide, acetylacetonate, nitrate, chloride, or a combination thereof.

16. The process of claim 15, wherein the surface coating comprises one or more of:
15 to 80 wt % of SiO₂;
0 to 50 wt % of CaO;
0 to 35 wt % of Al₂O₃;
1 to 20 wt % of MgO;
0 to 15 wt % of Na₂O;
0 to 15 wt % of K₂O;
0 to 15 wt % of Fe₂O₃;
0 to 25 wt % B₂O₃;
0 to 50 wt % of CaSO₄; and
0 to 15 wt % of TiO₂, wherein the amounts are based on the total weight of the surface coating.

17. The process of claim 15, wherein the surface coatings comprises borosilicate glasses.

18. The process of claim 15, wherein the combustion component comprises iron, steel, an alloy thereof, or a combination thereof.

19. The process of claim 15, wherein the surface coating has a coefficient of thermal expansion from 3 to 12 ppm/K.

20. The process of claim 1, wherein the combustion component is a piston, a fire deck, a combustion chamber, a valve, a pin, or a combination comprising at least one of the foregoing, preferably a bowl surface of the piston, a crown surface of the piston, top surfaces of the intake and exhaust valves, a top surface of a cylinder head exposed to a combustion chamber, a wall surface of the cylinder, an exhaust manifold, an exhaust piping, or a combination comprising at least one of the foregoing.

21. The process of claim 1, wherein the surface coating comprises one or more of:
a porosity of 0.1 to 30 vol %, based on the total volume of the surface coating;
a thickness of 0.002 to 1 mm;
a thermal conductivity of 0.25 to 2.5 W/m·K; and
a density of 1 to 5 g/mL.

22. The process of claim 1, wherein the coefficient of thermal expansion of the surface coating is 1 to 50% less than the coefficient of thermal expansion of the combustion component.

23. The process of claim 1, wherein the coefficient of thermal expansion of the surface coating is substantially the same as the coefficient of thermal expansion of the combustion component.

24. A coated combustion component manufactured by the process of claim 1.

25. An internal combustion engine comprising the coated combustion component of claim 24, wherein the engine is a gasoline engine or a diesel engine.

26. The internal combustion engine of claim 25, wherein a combustion efficiency of the internal combustion engine is 0.5 to 25% greater than a combustion efficiency of an internal combustion engine without the coated combustion component.
